(19) United States
(12) Patent Application Publication
(10) Pub. No.: US 2009/0049818 A1
(43) Pub. Date: Feb. 26, 2009

(54) Wheel guided lawn trimmer

(76) Inventor: Albert Richard Farquhar, Taft, CA (US)

Correspondence Address: Albert Richard Farquhar, 219 Madison st., Taft, CA, 93268, US

(21) Appl. No.: 11/894,375

(22) Filed: Aug. 20, 2007

(51) Int. Cl. A01D 34/84; A01D 34/416

(52) U.S. Cl. 56/16.7

(57) ABSTRACT

Wheel Guided Lawn Trimmer with The wheels on the lawn trimmer will help you cut around landscape easer than a trimmer without wheels, The weight of the trimmer without wheels is on the operator, the wheel guided lawn trimmer takes the weight of the trimmer, The average lawn enthusiast will master a trimmer with wheels, than to hold a trimmer steady while trimming around landscape, The three wheels used on the trimmer will balance the trimmer more efficiently than other trimmer that have deigned with wheels, The front swivel wheel has three cutting position while staying on the fresh cut lawn, Designed that have wheel that attach to the shaft of the shaft of the trimmer tends to have a balancing problem, and The wheel guided lawn trimmer eliminates the difficulties of deep or high cuts in the lawns that is encountered with a standard lawn trimmer.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Lawn and Garden, and more specifically to home lawn and garden enthusiast, who demand a even cut lawn around landscape with Wheel Guided Lawn Trimmer, that demand is met.

String trimmer were designed in the 1970's, The string trimmer is a hand-held cutting device, generally use for cutting soft vegetation and lawn that is inaccessible to a conventional lawn mower.

Over the years the string trimmer have became very popular for commercial and home and garden use, because of the easy maneuverability of this device around fences, buildings, sidewalk and landscape that rises above the lawn.

String trimmer must be supported by the operator at a desired height above the lawn for a prolong period of time, therefore the weight of the string trimmer would causes fatigue on the operator, becoming very difficult for the operator to keep the string trimmer at the right height on the lawn. The results would be a variation of heights in the lawn around fences, buildings and sidewalk.

With the many different design of wheels attached to the string trimmer that has been patented, recognized the problems of the operator having to carry the weight of the conventional string trimmer for for a prolong period of time.

There are string trimmer with a single shaft attached to the shaft and or the bottom of the string trimmer, with one wheel attach to the bottom of the shaft, ether solid or swivel wheels.

There are bipods and tripods that are attached to the shaft of the string trimmer with two and three wheels attach to the bottom of the bipods and or tripods ether solid or swivel.

There are three and four wheels dolly that the string trimmer is attach to. Some string trimmer are attach to a riding lawn mower, there are walk-behined string trimmer that's built on to a large two wheel dolly, with a 3 to 6 horsepower engine with a V-belt to power the string trimmer.

Recognizing problems associated with prior patented, with wheels on the string trimmer, the primary reason for the wheels are to relive the weight from the operator of trimmer, and put the weight of the string trimmer onto the trimmer itself.

There are string trimmer with a single wheel shaft, two wheels bipod and three wheels tripod that is attach to the shaft of the string trimmer, this design will remove the weight of the trimmer, but will increase the difficulty in balancing the trimmer evenly above the lawn, and causing uneven cut in the lawn.

The four wheel dolly for the string trimmer is would be like a miniature lawn mower, takes the weight of the string trimmer, the purpose of the string trimmer is to trim lawn and soft vegetation around landscape that rises higher than the lawn, with the wheels out side the cutting radius of the trimmer, that purpose is lost.

The string trimmer that is attach to the riding lawn mower has a problem of maneuvering the riding lawn mower through tight landscape.

The large two wheel dolly with a 3 to 6 horse power engine main purpose is cutting tall brush, in open fields.

The shortcomings and inadequacies in these design, are unlike the WHEEL GUIDED LAWN TRIMMER. The three wheels use on the trimmer will balance the trimmer more efficiently, maneuver easer with the front swivel wheel, with the wheel height adjustment the trimmer can adjust to any lawn. Feature like the front swivel wheel control arm can move 45 degrees ether to the left or right and lock in place, to give a larger cutting radius and to keep the wheels on even cut lawn while detailing the landscape. The WHEEL GUIDED LAWN TRIMMER work with the same technique as a household vacuum cleaner. Lawn and garden enthusiasts will master the WHEEL GUIDED LAWN TRIMMER with ease.

### BRIEF SUMMARY OF THE INVENTION

The primary object of the invention is a lawn trimmer to provide a neat and clean cut lawn that the lawnmower cannot get to.

The advantage of the wheels on the lawn trimmer is the ability to maneuver the lawn trimmer while keeping a level cut lawn.

The object of the invention is that, on a stander lawn trimmer, the weight of the trimmer has to be carried by the operator, but the wheels on the wheel guided lawn trimmer carried the weight.

Yet another object of the invention is, the wheel guided lawn trimmer works with the same technique as a household upright vacuum cleaner.

Yet another object of the invention is, feature like the front swivel wheel control arm can move 45 degrees ether to the left or right and lock in place, to give a larger cutting radius and to keep the wheels on even cut lawn while detailing the landscape.

Still yet another object of the invention is, the wheels on the wheel guided lawn trimmer has adjustment screws, so your string line trimmer can be adjusted to the height of your lawn.

Another object of the invention is, with the wheel guided lawn trimmer, the two wheels in the back and the one front swivel wheel creates a balance trimmer while giving more cutting area.

Another object of the invention is, the most advantage of the wheel guided lawn trimmer is that the weight of the trimmer is on the wheels its self and not on the operator.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Wheel Guided Lawn Trimmer comprising: The wheels on the lawn trimmer will help you cut around landscape easer than a trimmer without wheels, The weight of the trimmer without wheels is on the operator, the wheel guided lawn trimmer takes the weight of the trimmer, The average lawn enthusiast will master a trimmer with wheels, than to hold a trimmer steady while trimming around landscape, The three wheels used on the trimmer will balance the trimmer more efficiently than other trimmer that have deigned with wheels, The front swivel wheel will slide from side to side and lock in place to give you more cutting area while staying on the fresh cut lawn, Trimmer that have been designed with wheels outside the cutting edge takes away the ability to cut next to the elevated landscape, Designed that have wheel that attach to the shaft of the trimmer with two wheels in a bypod position tends to have a balancing problem, and The wheel guided lawn trimmer eliminates the difficulties of deep cuts and high cuts in the lawns that is encountered with a standard lawn trimmer without wheels.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan side view of the Wheel Guided Lawn Trimmer, modified form a standard electric power string trimmer consisting of wheels, swivel wheel, a modified base plate pivoting arm for the swivel wheel, electric motor shield, and motor shaft for the spool and line housing.

FIG. 2 is a plan top view of the Wheel Guided Lawn Trimmer, modified form a standard electric power string trimmer, as shown in FIG. 1.

FIG. 3 is a plan bottom view of the Wheel Guided Lawn Trimmer, modified for a standard electric power string trimmer, as shown in FIG. 1.

(Note) The shaded area represent a typical string trimmer.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

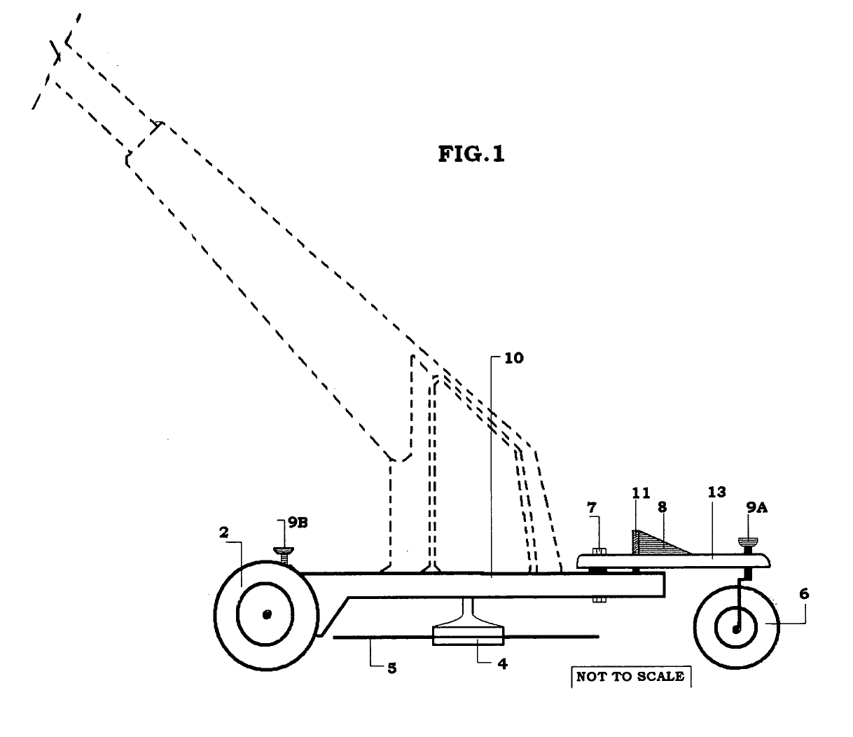

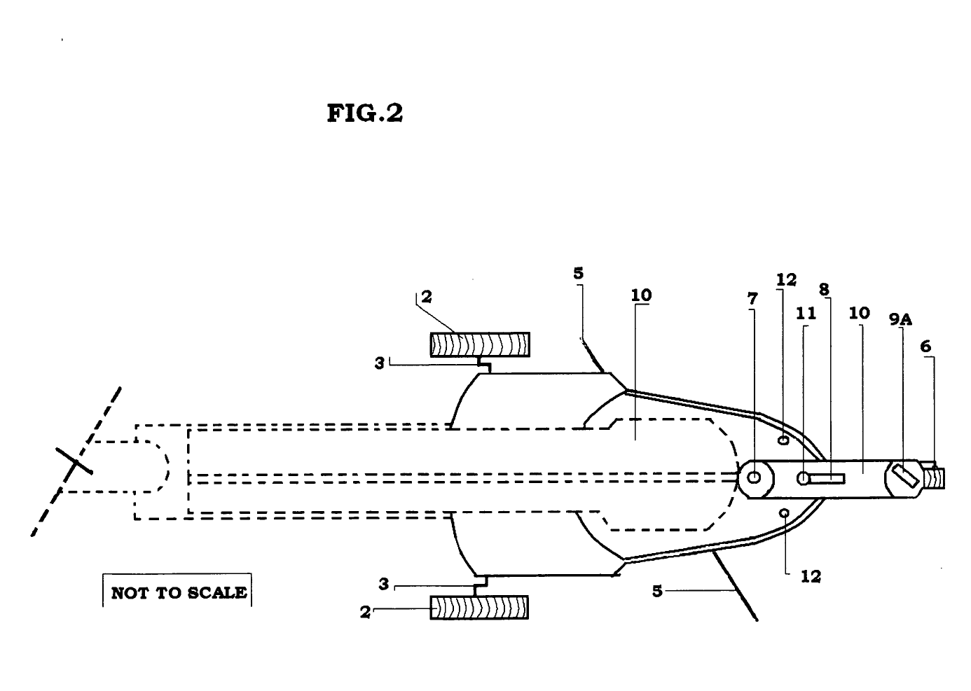

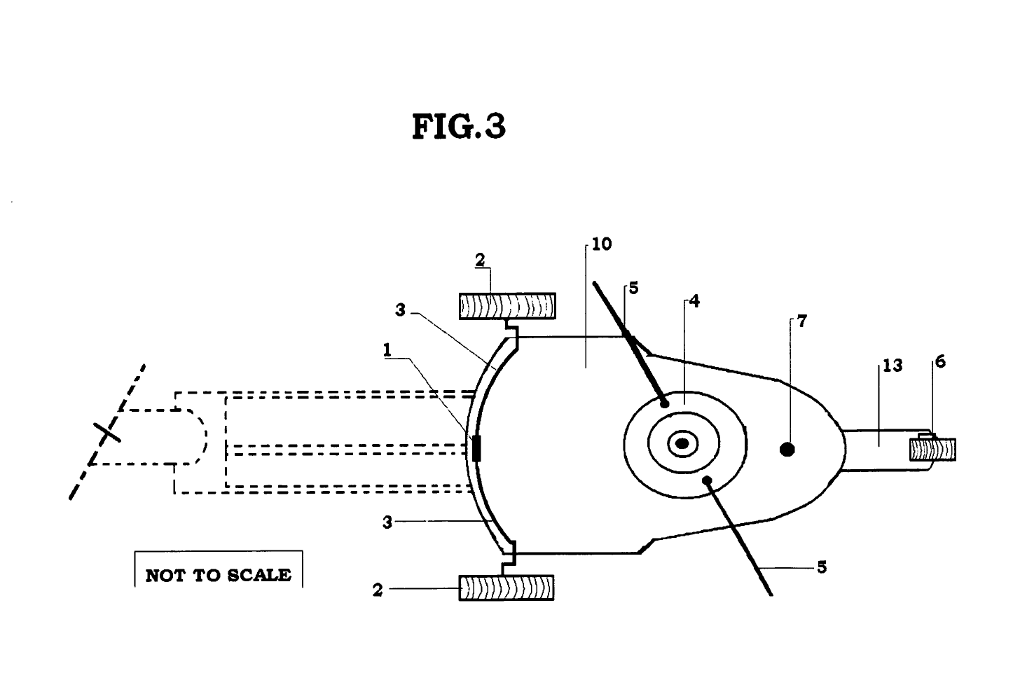

Turning first to ( FIG. 1) of the drawings, typical string trimmer with a modified base plate (10.) with adjustable wheels in the rear, and in the front of the modified base plate (2), adjusted with a square thread Teflon screw that is screw into a square thread Teflon nut (the Teflon screw and nut prevents the grass from sticking, and gaulding the screw and nut together) that is imbedded into the base plate (9B) of the Wheel Guided Lawn Trimmer. The square thread Teflon screw (FIG. 3) is attached to a (1.) carrier bracket that is attach to (3). the rear adjustable axle. (FIG. 1) When the square thread Teflon screw (9B) is turn to the right the rear wheels (2) will rise the rear of base plate higher off of the lawn, and when the square thread Teflon screw (9B) is turn to the left the rear wheels (2) will lower the base plate closer to the lawn. The control arm (13) is attach to the base plate (10) by a nut and bolt (7) separated by a Teflon washer (14), The center of the control arm (11) is a cylinder with a spring loaded Teflon ball, that has a handle attach to it (8) That will fall into 3 setting 45% right 90% and 45% left (12), as seen in ( FIG. 2) This allow the control arm to keep the wheel on a even cut surface of the lawn. (FIG. 1) The control arm (13) is guided by a swivel wheel (6) that is adjusted by a square thread Teflon screw (9A) to adjust the height of the swivel wheel (6). The shaft of the motor has a flat bottom string line carrier (4) To Carrie the string (5) closer to the lawn with out interference.

Referring to (FIG. 1 and FIG. 2) of the drawings, the modified base plate (10) rear axle (3) the axle is curved around the back of the base plate (10) to prevent the nylon string from hitting the axle. The axle is Z bent (3) out of the base plate and to the rear of the base plate (10) in line with the carrier bracket (1). In the center of the axle(3). The carrier bracket is attach the the square thread Teflon screw (FIG. 1, 9B) when the square thread Teflon screw is turn left or right the base plate will move up or down.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Wheel Guided Lawn Trimmer comprising:
The wheels on the lawn trimmer will help you cut around landscape easer than a trimmer without wheels;
The weight of the trimmer without wheels is on the operator, the wheel guided lawn trimmer takes the weight of the trimmer;
The average lawn enthusiast will master a trimmer with wheels, than to hold a trimmer steady while trimming around landscape;
The three wheels used on the trimmer will balance the trimmer more efficiently than other trimmer that have deigned with wheels;
The front swivel wheel will slide from side to side and lock in place to give you more cutting area while staying on the fresh cut lawn;
Trimmer that have been designed with wheels outside the cutting edge takes away the ability to cut next to the elevated landscape;
Designed that have wheel that attach to the shaft of the shaft of the trimmer with two wheels in a bypod position tends to have a balancing problem; and
The wheel guided lawn trimmer eliminates the difficulties of deep cuts and high cuts in the lawns that is encountered with a standard lawn trimmer without wheels.
